(19) United States
(12) Patent Application Publication
(10) Pub. No.: US 2001/0042132 A1
(43) Pub. Date: Nov. 15, 2001

(54) System and method for targeting and serving messages based on complex user profiles

(76) Inventor: Vijay Mayadas, Boston, MA (US)

Correspondence Address: PERKINS, SMITH & COHEN LLP, ONE BEACON STREET, 30TH FLOOR, BOSTON, MA, 02108, US

(21) Appl. No.: 09/821,003

(22) Filed: Mar. 29, 2001

Related U.S. Application Data
(60) Provisional application No. 60/192,968, filed on Mar. 29, 2000.

(51) Int. Cl. G06F 15/173; G06F 15/16

(52) U.S. Cl. 709/238; 709/207

(57) ABSTRACT

The system enables an advertiser to target a message to a specific user based on a target profile. User profiles stored in the system are compared to the target profile in order to obtain a list of users to whom the targeted message should be served. The system then serves out the appropriate advertisements to those users when those users access the system or a branch of the system. A branch of the system may be a computer display or a cell phone or a computer kiosk.

### CROSS-REFERENCE TO RELATED APPLICATIONS

This application claims priority of U.S. provisional applications Ser. No. 60/192,968 entitled, “System and Method for Targeting and Serving Messages Based on Complex User Profiles” filed Mar. 29, 2000 by the present applicant.

### FIELD OF THE INVENTION

This invention relates generally to information delivery and more particularly to targeting messages to users based on user profiles.

### BACKGROUND OF THE INVENTION

Present advertisement targeting technology is limited to targeting to the media the advertisement will be placed in rather than to the actual viewer of the advertisement. Some present systems use passive profile information gathered by tracking a user's habits without their knowledge. This information is naturally limited by the pre-conceived habits tracked. The imperfect information leads to imperfect targeting.

It remains desirable to direct messages at users rather than at media.

It is an object of the present invention to provide a method and apparatus to target messages at a selected audience rather than broadcast messages to a general audience.

### SUMMARY OF THE INVENTION

The problems of directing messages toward users most likely to respond to (and, a fortiori, to read) the messages are solved by the present invention of a system and method for targeting and serving messages based on personalized user profiles.

The system enables an advertiser to target a message to a specific user based on a target profile. User profiles stored in the system are compared to the target profile in order to obtain a list of users to whom the targeted message should be served. The system then serves out the appropriate targeted messages to those users when those users access the system or a branch of the system. A branch of the system may be a computer display or a cell phone or a computer kiosk.

In the system, messages can be targeted on profiles with any level of specificity, from “all males” to “pizza lovers who live in 02143 and drive a BMW.” Flexible and open-ended message targeting allows targeted message sponsors, such as advertisers, to focus on only those people they are interested in reaching.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of a message targeting system according to principles of the invention;

FIG. 2 is a block diagram of a portion of a profile tree of the system of FIG. 1;

FIG. 3 is a block diagram of the targeted message repository of the system of FIG. 1; and,

FIG. 4 is a flow chart of the operation of the message targeting system of FIG. 1.

### DETAILED DESCRIPTION OF PREFERRED EMBODIMENTS

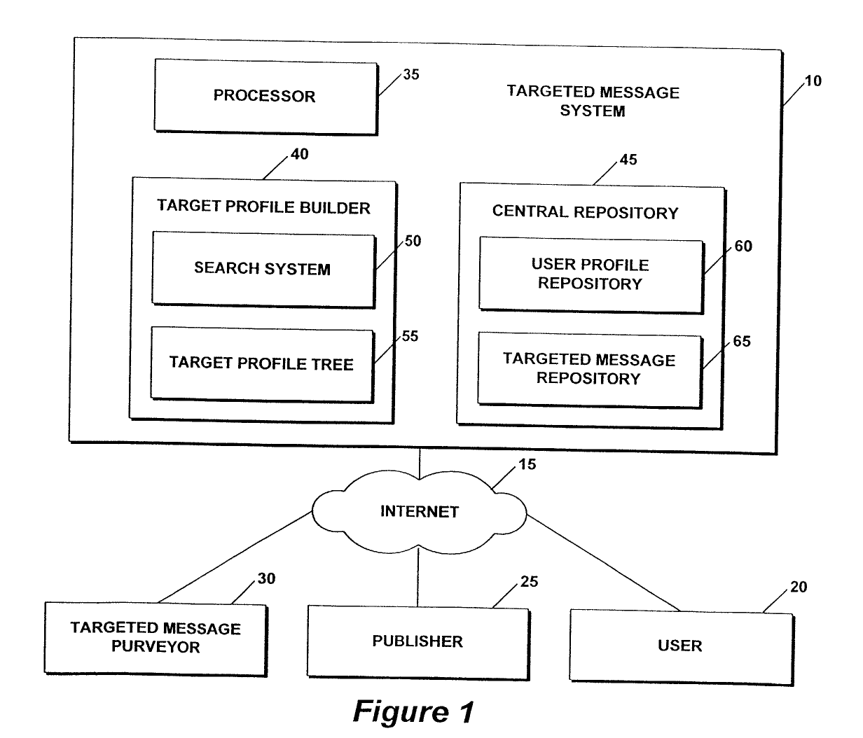

FIG. 1 is a block diagram of a message targeting system according to principles of the present invention.

The message targeting system 10 is connected to the Internet 15 where it is accessible to users 20, publishers 25 and sponsors of targeted messages 30. The system 10 has a processor 35, a target profile builder 40 and a central repository 45. The target profile builder 40 has a search system 50 and a target profile tree 55. The central repository 45 has a user profile repository 60 and a targeted message repository 65.

In operation, the sponsor of targeted messages 30 provides a targeted message that is stored in the targeted message repository 65. The sponsor of targeted messages also builds a target profile to be associated with the targeted message using the tools provided on the system 10. The target profile is a profile of characteristics of the intended receiver of the targeted message. The target profile tree 55 is a database of characteristics with which to build the target profile. The target profile is stored in the targeted message repository 65 with the targeted message. The search system 50 searches user profiles in the user profile repository 60 for matches between user profiles and the target profile. All the users who meet the target profile characteristics are listed in the targeted message repository 65 in association with the targeted message. When a registered user, that is, a user 20 having a user profile, accesses the system through a publisher 25, the user is identified and the search system 50 searches the targeted message repository 65 for any targeted messages to be shown to that user. The system 10 selects a targeted message from the messages found in the targeted message repository 65 and displays it to the user 20 through the publisher.

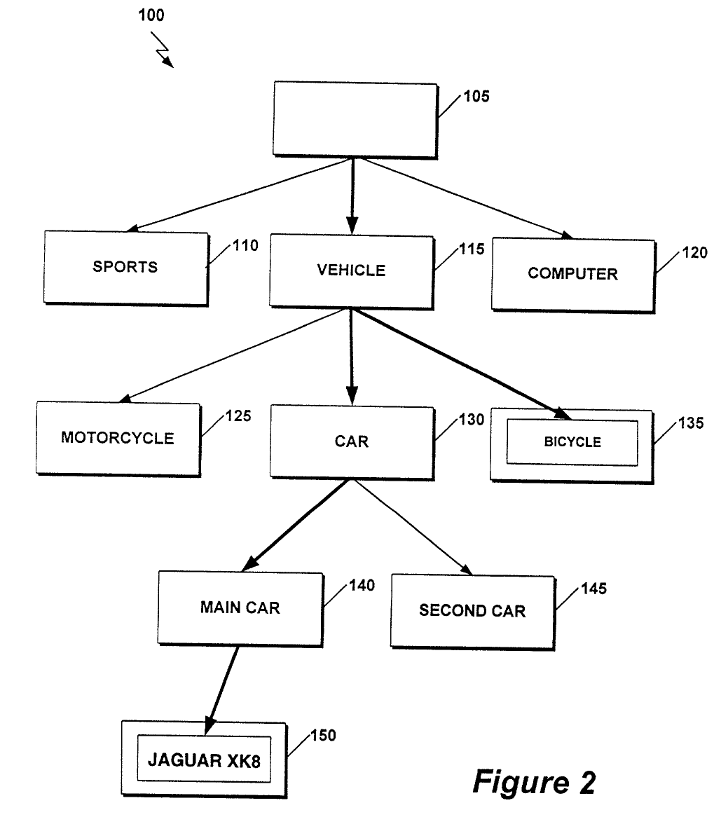

FIG. 2 is a block diagram of a portion of the target profile tree 55. When a sponsor of targeted messages, such as an advertiser, is interested in sending a targeted message, such as an advertisement, to users, the advertiser must construct an advertisement campaign. One component of that campaign is the target profile. The target profile determines who sees the advertisement.

In order to construct the target profile, the advertiser browses through the target profile tree, checking off all attributes that the target user should match. These profile points determine who is shown the advertisement.

The profile tree works by successively dividing all things into categories. For example, “vacations” might be subdivided into Caribbean and European, etc. There is no requirement that profiles draw from only one part of the tree so “pizza lovers who drive BMW's” is a valid target profile.

Referring now to FIG. 2, the portion 100 of the target profile tree 55 is given a “local root” 105 for illustration purposes. From the local root 105 extend the categories of sports 110, vehicle 115 and computer 120. From the vehicle category 115 extend the categories of motorcycle 125, car 130 and bicycle 135. From the category of car 140 extend the category of main car 140 and second car 145. From the category of main car 140 extends the category of Jaguar XK8 150. The advertiser steps through the target profile tree and in this portion of the target profile tree, selects bicycle 135, the Jaguar XK8 150 under main car. The selected categories become the target profile which will be associated with the targeted message and will be used to search the user profiles for matching users.

Once a target profile is constructed, the system 10 can tell the advertiser how many people presently in the system match the profile so that the advertiser receives an estimate of the size of the target audience. The system updates the lists of users associated with particular targeted messages to keep the lists up-to-date. When new users join, or when a current user updates his or her profile, the lists of users associated with the various targeted messages are updated accordingly. In alternative embodiments of the system, the target profiles are periodically reviewed and compared to the user profiles.

Using the target profile, the advertiser can target a more specific set of people than is presently possible. Also, this targeting method can grow more and more specific as the system grows and the user profiles become richer.

The preferred implementation is a web site with a tree of web pages to allow profile construction. This is backed up by Java servlets accessing the relational database that holds the profiles and the advertisement information.

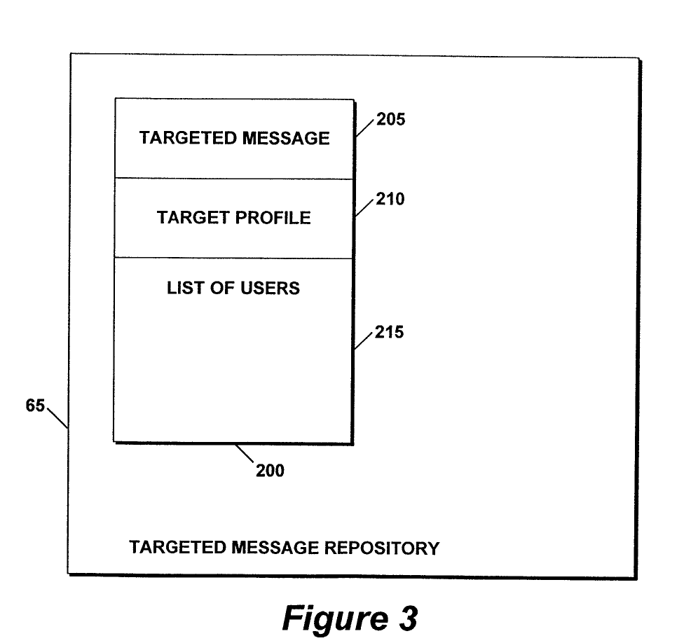

FIG. 3 shows the targeted message repository 65 with a generic record 200. The generic record 200 has a targeted message field 205 with a target profile field 210 and an associated list of users 215 created when the target profile is matched to the stored user profiles.

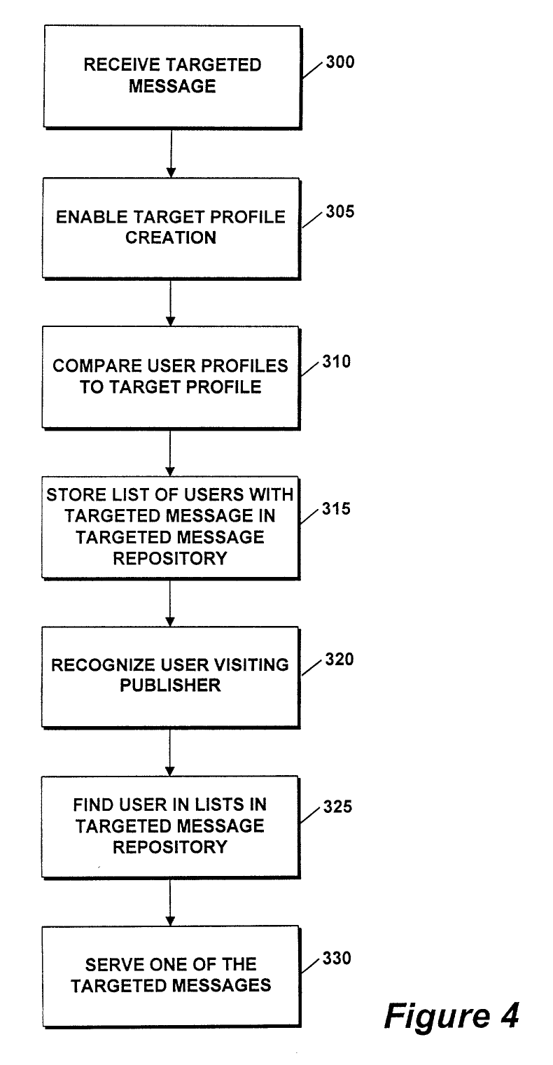

FIG. 4 is a flow chart of the operation of the system. The system receives a targeted message, block 300, from for example an advertiser. The system enables the advertiser to create a target profile by providing the target profile tree, block 305. Once the advertiser has created the target profile, the user profiles stored in the system are compared to the target profile, block 310. The resulting list of users is stored in the targeted message repository along with the targeted message, block 315. Whenever a registered user visits a publisher of targeted messages, the system first recognizes the user, block 320, that is, the system confirms that a user profile is stored in the user profile repository. Then the system searches for the user in the lists stored in the targeted message repository, block 325. The system may find no appropriate targeted message or a plurality of targeted messages to display to the user, block 330. One of the found targeted messages is then served to the user.

In a first alternative embodiment of the invention, the system creates links from the user profiles to targeted messages in the targeted message repository when the user profiles are compared to the target profile. In this embodiment, when a user is recognized at a publisher, a list of targeted messages already exists. One of the targeted messages is then served to the user at the publisher.

In a second alternative embodiment of the invention, the system recognizes a user at a publisher and compares that user's profile to the target profiles stored in the central repository. If a matching target profile is found, the associated targeted message is served to the user.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A computer-implemented method for providing a targeted message to a user, comprising the steps of:
receiving a targeted message and an associated target profile;
comparing said target profile to stored user profiles;
associating matching user profiles with said targeted message;
comparing an accessing user to said matching user profiles; and,
if a match between said accessing user and said matching user profiles is found, providing said targeted message to said accessing user.

2. The method of claim 1 further comprising the steps of:
providing a target profile tree; and
building said target profile using said target profile tree in response to specifications associated with said received targeted message.

3. The method of claim 2 wherein said target profile tree is a tree of web pages.

4. The method of claim 2 wherein the step of building a target profile comprises stepping through said target profile tree, each step in response to input from a user.

5. The method of claim 1 further comprising the step of reporting a count of user profiles matching said target profile.

6. The method of claim 1 further comprising the steps of:
recomparing periodically said target profile with said stored user profiles; and
associating matching user profiles found in said recomparing step with said targeted message.

7. The method of claim 1 wherein said step of associating further comprises storing said user profiles with said targeted message in a database record.

8. The method of claim 1 wherein said step of associating further comprises creating links from said user profiles to said targeted message.

9. A system to provide a targeted message to a user having a user profile, comprising:
a target profile builder to build a target profile in response to a received targeted message;
a user profile repository to store user profiles;
a search system to search said user profile repository for matches to said target profile; and
a targeted message repository to store the targeted message and associations to matching user profiles, said targeted message repository to be search with said search system in response to access of the system by a user
whereby the targeted message is provided to said user if a match in said targeted message repository is found.

10. The system of claim 9 wherein said targeted message repository further comprises at least one database record to store said targeted message and said matching user profiles.

11. The system of claim 9 wherein said targeted message repository further comprises at least one database record to store said targeted message and links to said matching user profiles.
